(19) United States
(12) Patent Application Publication
(10) Pub. No.: US 2026/0332935 A1
(43) Pub. Date: Oct. 22, 2026

(54) Shape-Retaining Ear Hook for Audio Devices

(71) Applicant: Amzaleg's, LLC, Woodland Hills, CA (US)

(72) Inventors: Or Amzaleg, Woodland Hills, CA (US); Adam Amzalag, Woodland Hills, CA (US)

(21) Appl. No.: 19/315,123

(22) Filed: Aug. 29, 2025

(51) Int. Cl. H04R 1/10

(52) U.S. Cl. CPC H04R 1/105; H04R 1/1066

(57) ABSTRACT

A system for positioning an earbud relative to the ear of a person includes an ear frame that extends between a first end and a second end, having a top portion disposed between the ends. The system includes an earbud receiver configured to receive a stem of an earbud, connected to the ear frame. A malleable core element is embedded within the ear frame, having sufficient plasticity to undergo permanent deformation when subjected to manual bending forces while maintaining structural integrity, whereby the ear frame retains a user-configured shape after manual adjustment. An elastomeric covering encases the malleable core element. The malleable core element comprises materials such as copper wire having a yield strength between 40-200 MPa and enables customizable, personalized fit solutions superior to conventional elastic ear hooks.

### TECHNICAL FIELD

The invention generally relates to an earbud retention and stabilization system. More particularly, the invention relates to an earbud retention and stabilization system that incorporates a malleable core element enabling earbud headphones to be retained relative to the ears of a user through user-adjustable shape retention.

### BACKGROUND

Earbuds have become very common and popular over the past few years. Earbuds are speaker headsets where the speaker is small enough to fit inside the ear. Earbuds are supplied with many portable music players and with most cell phones.

Wireless earbuds are available. These wireless earbuds have the same fit, comfort, and stability issues as the wired earbuds. Newer wireless earbuds also present the bigger issue of simple loss if an earbud falls out. With the high cost of these new wireless earbuds, loss is a significant issue. Such earbuds include Apple AirPods Pro®, Apple AirPods (1st Generation)®, Apple AirPods (2nd Generation)®, and Apple AirPods (3rd Generation)®. The earbud may include, for example, a speaker section that is configured to be at least partially received in the outer ear of the user. The earbud further includes a stem extending from the speaker section to a distal point. The stem may define a circular outer cross section in a plane perpendicular to the axis of the stem. The stem may include a microphone proximate to its distal end and the stem may include an interface on a surface thereof that can be tactically actuated.

Earbuds are especially troublesome if the user is active or moving. Jogging, biking, skiing, working out, or simply walking are all example activities that can cause earbuds to fall out. Sometimes just turning one's head can cause earbuds to come out. To prevent this, some users will push the earbuds further in their ear, leading to discomfort.

Traditional ear hook solutions exist, typically made from purely elastic materials such as silicone or rubber. These conventional ear hooks suffer from significant limitations in that they provide a “one-size-fits-most” approach that cannot accommodate the wide variation in human ear anatomy. Such elastic ear hooks return to their original molded shape regardless of user adjustment attempts, failing to provide personalized fit solutions.

Existing ear hook designs also lack the ability to maintain user-customized configurations. When a user attempts to adjust a conventional elastic ear hook to better fit their ear contour, the elastic material simply returns to its original shape, negating any potential comfort or retention improvements.

Thus, there exists a need in the art for an improved system and method for retaining the ear bud relative to the ear of a user that provides customizable, user-adjustable shape retention while maintaining structural integrity and comfort.

### SUMMARY OF THE INVENTION

The needs set forth herein as well as further and other needs and advantages are addressed by the present teachings, which illustrate solutions and advantages described below.

The present invention resides in one aspect in a system for positioning an earbud relative to the ear of a person. The system comprises an ear frame extending between a first end and a second end, the ear frame having a top portion disposed between the first end and the second end, the ear frame defining a first side that is adjacent to a head of the person and a second side that is oppositely disposed relative to the first side. The system further includes an earbud receiver configured to receive a stem of an earbud, the earbud receiver connected to the ear frame proximate to the first end of the frame, the earbud receiver having a receiving channel. A malleable core element is embedded within the ear frame, the malleable core element having sufficient plasticity to undergo permanent deformation when subjected to manual bending forces while maintaining structural integrity, whereby the ear frame retains a user-configured shape after manual adjustment. An elastomeric covering encases the malleable core element.

In yet a further embodiment of the present invention, the malleable core element has a yield strength between 40 and 200 MPa.

In yet a further embodiment of the present invention, the malleable core element has a diameter between 0.016 inches and 0.040 inches.

In yet a further embodiment of the present invention, the malleable core element comprises a metal selected from the group consisting of copper, aluminum, brass, zinc, and alloys thereof.

In yet a further embodiment of the present invention, the yield strength of the malleable core element exceeds the tensile strength of the elastomeric covering by a factor of at least 5:1.

In yet a further embodiment of the present invention, the malleable core element extends along the length of the ear frame between the first end and the second end.

In yet a further embodiment of the present invention, the elastomeric covering comprises silicone having a Shore A hardness between 20 and 80.

In yet a further embodiment of the present invention, the malleable core element has an elongation at break of at least 10%.

The present invention resides in yet another aspect in an ear hook for an earbud having a stem extending therefrom. The ear hook comprises an ear frame extending between a first end and a second end and defining a C-shape between the first end and the second end; an earbud receiver connected to the first end of the ear frame, the earbud receiver configured to receive the stem of the earbud; a wire core embedded within the ear frame, the wire core having a yield strength between 70 and 150 MPa and a diameter between 0.020 inches and 0.035 inches, the wire core being sufficiently malleable to permit manual reshaping while providing shape retention after deformation; and a silicone covering molded around the copper wire core.

In yet a further embodiment of the present invention, the wire core comprises copper.

In yet a further embodiment of the present invention, the copper wire core has a gauge between 18 AWG and 26 AWG.

In yet a further embodiment of the present invention, the copper wire core comprises oxygen-free copper.

In yet a further embodiment of the present invention, the silicone covering has a tensile strength between 2 and 8 MPa.

In yet a further embodiment of the present invention, the copper wire core has a yield strength between 70 and 100 MPa.

In yet a further embodiment of the present invention, the copper wire core comprises a solid conductor.

In yet a further embodiment of the present invention, the copper wire core extends continuously from proximate the first end to proximate the second end of the ear frame.

The present invention resides in yet another aspect in a customizable ear retention device comprising a curved frame portion configured to extend around at least a portion of a user's ear; an earbud coupling portion connected to the curved frame portion; a shape-memory element incorporated within the curved frame portion, the shape-memory element being manually deformable to assume and retain a user-selected configuration; and a flexible outer layer surrounding the shape-memory element.

In yet a further embodiment of the present invention, the shape-memory element comprises a material selected from the group consisting of metals, metal alloys, thermoplastic elastomers, fiber-reinforced polymer composites, and shape memory polymers.

In yet a further embodiment of the present invention, the shape-memory element has mechanical properties enabling permanent deformation under manual force while resisting deformation under normal use conditions.

In yet a further embodiment of the present invention, the flexible outer layer comprises a material having elastic properties substantially different from the shape-memory element.

In yet a further embodiment of the present invention, the shape-memory element extends along a majority of the length of the curved frame portion.

In yet a further embodiment of the present invention, the earbud coupling portion is configured to receive earbuds of different manufacturers.

In yet a further embodiment of the present invention, the device is configured for use with wireless earbuds.

In yet a further embodiment of the present invention, the curved frame portion is configured to extend over the ear of the user when in use.

In yet a further embodiment of the present invention, the shape-memory element provides the primary structural support for the curved frame portion.

These and other aspects of the present invention will become apparent in light of the drawings and detailed description provided below. The needs set forth herein as well as further and other needs and advantages are addressed by the present teachings, which illustrate solutions and advantages described below.

### BRIEF DESCRIPTION OF THE DRAWINGS

FIG. 1 illustrates a front, top, and left perspective view of an ear hook for an earbud in accordance with one embodiment of the present invention.

FIG. 2 is a left side elevational view of the ear hook shown in FIG. 1, illustrating the malleable wire core with hidden dashed lines and section indicators.

FIG. 3 is a right side elevational view of the ear hook shown in FIG. 1.

FIG. 4 is a rear elevational view of the ear hook shown in FIG. 1, illustrating the malleable wire core with hidden dashed lines.

FIG. 5 is a front elevational view of the ear hook shown in FIG. 1.

FIG. 6 is a left side elevational view showing the earbud receiver configuration.

FIG. 7 is a right side elevational view showing the earbud receiver configuration with adjustment mechanism.

FIG. 8 is a cross-sectional view AA showing the malleable wire core embedded within the elastomeric covering.

FIG. 9 is a cross-sectional view BB showing the malleable wire core embedded within the elastomeric covering.

FIG. 10 is a rear elevational view of an ear hook in accordance with one embodiment of the present invention, illustrating a malleable wire core with hidden dashed lines.

FIG. 11 is a rear elevational view of an ear hook in accordance with one embodiment of the present invention, illustrating a malleable wire core with hidden dashed lines.

FIG. 12 is a rear elevational view of an ear hook in accordance with one embodiment of the present invention, illustrating a malleable wire core with hidden dashed lines.

### DETAILED DESCRIPTION

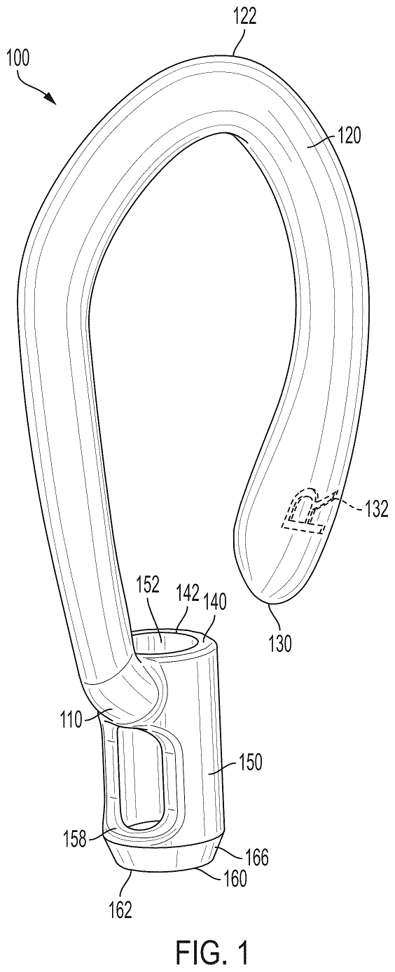

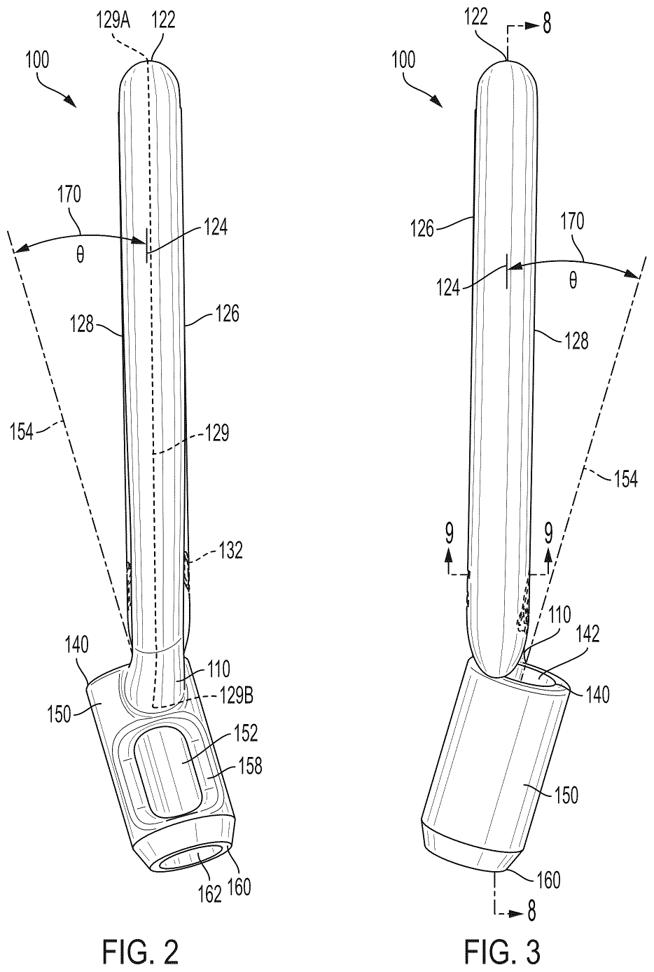

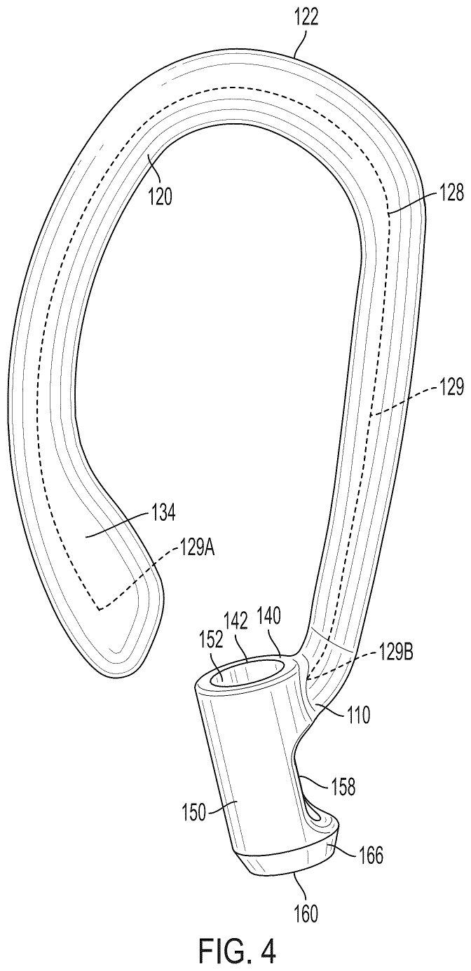

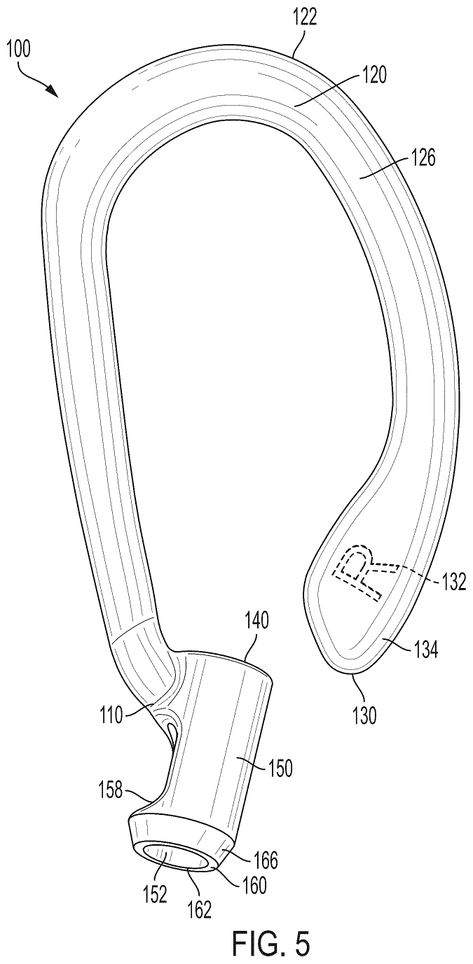

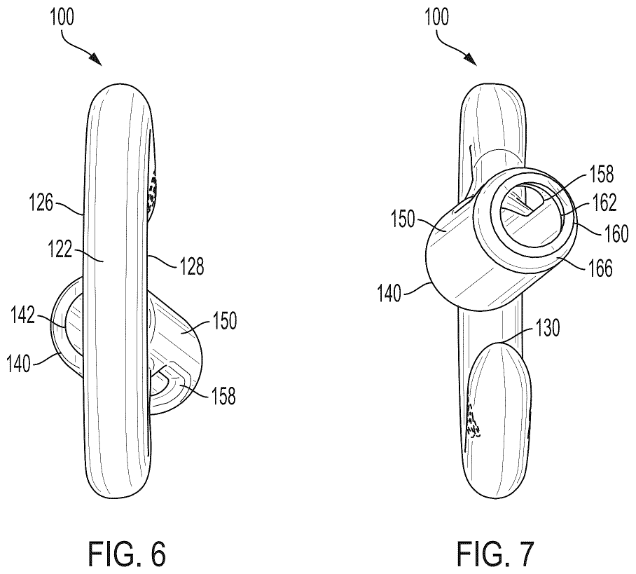

In reference to FIGS. 1-9, a system 100 for positioning an earbud relative to the ear of a person is shown. The system 100 may also be referred to as an ear hook herein. The ear hook 100 in accordance with the present invention is configured to be used on the left side or the right side of the body. In some embodiments of the present invention, the ear hook 100 is configured to retain an ear bud on right side of the body, namely in position relative to the right ear of the wearer. In another embodiment of the present invention, the ear hook 100 may be configured to retain an ear bud on the left side of the body, namely in position relative to the left ear of the wearer. In some embodiments of the present invention, the ear hooks 100 are provided as a pair that includes an ear hook for the right side of the body and an ear hook for the left side of the body.

The system for positioning and or fixing an earbud relative to the ear of a person 100 includes an ear frame 120 and an earbud receiver 150. The ear frame 120 extends between a first end 110 and a second end 130. The ear frame 100 is similar in form to the tip of the temple portion of eye glass frames. The ear frame 100 is shaped so that the first end is proximate to the ear canal and more specifically proximate to the intertragic notch of the ear. The ear frame 120 extends over the top of the ear between the helix and the side of the head and extend to the second end of the ear frame 130. The C-shape of the ear frame 120 is configured to hook across the top of the ear in the above described manner and retain the system 100 in position relative to the ear of the user.

The present invention incorporates a malleable core element 129 embedded within the ear frame 120. The malleable core element 129 represents a significant advancement over conventional elastic ear hook designs. Unlike traditional ear hooks that return to their original molded shape after deformation, the malleable core element 129 enables the ear frame 120 to retain user-customized shapes after manual adjustment.

The malleable core element 129 comprises a wire or rod-like structure having sufficient plasticity to undergo permanent deformation when subjected to manual bending forces while maintaining structural integrity. In some embodiments, the malleable core element 129 extends substantially along the entire length of the ear frame 120, from proximate the first end 110 to proximate the second end 130, providing comprehensive shape-retention capabilities throughout the ear hook structure.

In some embodiments, the malleable core element 129 comprises metals or metal alloys selected for their optimal malleability characteristics. Suitable materials include copper, aluminum, brass, zinc, and alloys thereof. The malleable core element 129 has a yield strength between 40 and 200 MPa, and more preferably between 70 and 150 MPa, ensuring that the material can be manually deformed by average users while providing adequate structural support.

The malleable core element 129 has a diameter between 0.016 inches and 0.040 inches, corresponding to wire gauges between approximately 18 AWG and 26 AWG. In some embodiments utilizing copper wire, the core element 129 has a diameter between 0.020 inches and 0.035 inches (approximately 20-22 AWG), providing an optimal balance between bendability and structural integrity.

In specific embodiments, the malleable core element 129 comprises copper wire, which provides excellent malleability characteristics. The copper wire may be annealed copper, which offers enhanced malleability compared to work-hardened copper. Oxygen-free copper may be used to provide superior corrosion resistance and maintain consistent mechanical properties over time. The copper wire core provides a yield strength between 70 and 150 MPa, enabling manual reshaping while maintaining shape retention after deformation.

The selection of specific yield strength ranges for the malleable core element 129 enables precise differentiation between various material categories and performance classes. Materials having yield strengths in the lower range of 40-70 MPa, such as annealed aluminum alloys (6061-T0 at approximately 55 MPa) or soft copper compositions, provide maximum user-friendliness requiring minimal force for reshaping while maintaining adequate structural integrity for lightweight earbud applications. Mid-range yield strengths of 70-120 MPa, exemplified by standard annealed copper (70-90 MPa), half-hard copper alloys (90-110 MPa), and certain brass compositions (80-120 MPa), offer an optimal balance between ease of customization and shape retention stability suitable for most consumer applications. Higher yield strength materials in the 120-200 MPa range, including work-hardened copper (150-180 MPa), aluminum 6061-T6 (275 MPa, though requiring size adjustment for manual bendability), and certain zinc alloys (120-160 MPa), provide maximum shape retention and structural support for heavy-duty applications or users requiring enhanced durability. This yield strength stratification allows for product line differentiation where “Easy Bend” variants (40-70 MPa) target users prioritizing effortless customization, “Standard” variants (70-120 MPa) serve general consumer needs, and “Pro” or “Sport” variants (120-200 MPa) address demanding applications requiring maximum shape retention under repeated stress. The specific yield strength selection also determines the cross-sectional area requirements, where lower yield strength materials may utilize larger diameters to achieve equivalent structural performance, while higher yield strength materials enable more compact cross-sections for sleeker product profiles.

The malleable core element 129 is encased within an elastomeric covering that provides comfort, grip, and protection for the internal core structure. The elastomeric covering comprises materials such as silicone, having a Shore A hardness between 20 and 80. The covering material has a tensile strength significantly lower than the yield strength of the malleable core element 129, typically between 2 and 8 MPa, ensuring that deformation forces are transmitted to the core element rather than causing failure in the covering material.

The yield strength of the malleable core element 129 exceeds the tensile strength of the elastomeric covering by a factor of at least 5:1, and typically 10:1 or greater. This relationship ensures that when a user applies bending forces to customize the ear hook shape, the forces are transmitted through the elastomeric covering to the malleable core element 129, which then undergoes controlled plastic deformation while the covering returns to its original form around the newly shaped core.

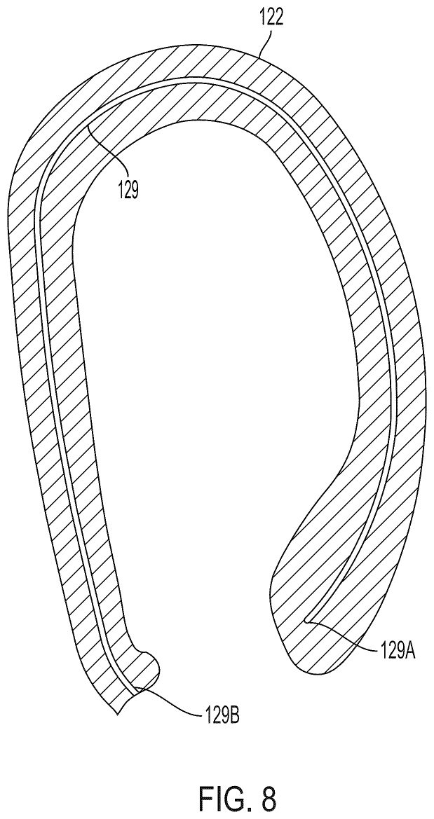

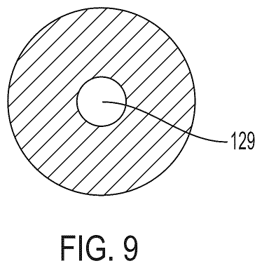

As illustrated in FIGS. 8 and 9, cross-sectional views AA and BB show the malleable core element 129A and 129B respectively, embedded within the elastomeric covering. The core element appears as a solid circular or oval cross-section centered within the covering material, demonstrating the concentric construction that enables force transmission while maintaining structural integrity.

The ear frame 120 defines a convex arcuate surface in a plane perpendicular to the length of the ear frame 120 between the first end 110 and the second end 130. The cross section becomes flatter toward an area 134 proximate to the second end 130 of the ear frame 120 to provide an additional support surface extending substantially parallel to an adjacent portion of the wearer's head proximate thereto.

The ear frame 120 has a first side 126 that is adjacent to a head of the person when the ear frame 120 is received over the ear of the user. The ear frame 120 defines a second side 128 that is oppositely disposed relative to the first side 126. The ear frame 120 includes a top portion 122. The ear frame 120 defines an ear frame plane 124 that extends between the first end 110, the second end 130, and the upper portion 122. The ear frame 120 may include angular indicators 170 showing the relationship between various structural elements.

The system 100 further includes an earbud receiver 150 connected to the first end 110 of the ear frame 120. The ear bud receiver 150 is configured to receive the stem of an earbud. The ear bud receiver 150 extends between a first end 140 and a second end 160. The ear bud receiver 150 defines a bore 152 that extends along an earbud receiver axis 154 from a first opening 142 at the first end 140 of the earbud receiver to a second opening 162 at the second end 160 of the earbud receiver 150. The earbud receiver 150 includes a recess 158 that provides access to interface elements of inserted earbuds. The second end 160 of the earbud receiver 150 may include a bezel 166 surrounding the second opening 162.

The earbud receiver 150 may include interface elements 132 positioned to interact with corresponding features on earbud stems. These interface elements 132 can include tactile access points, grip features, or alignment guides that enhance the connection between the earbud and the receiver 150. The positioning and configuration of interface elements 132 are coordinated with the recess 158 to provide optimal functionality for different earbud designs.

The present invention enables users to customize the fit of the ear hook through manual adjustment of the malleable core element 129. Users can grasp the ear frame 120 and apply controlled bending forces to reshape the C-curve to match their individual ear anatomy. The malleable core element 129 undergoes plastic deformation under these forces, retaining the new shape after the bending force is removed. This provides each user with a truly personalized fit that conventional elastic ear hooks cannot achieve.

Unlike conventional elastic ear hooks that exhibit spring-back behavior, the malleable core element 129 provides permanent shape retention. Once a user has customized the ear hook configuration, the device maintains that shape during normal use conditions. The yield strength characteristics of the malleable core element 129 are selected to resist deformation under normal insertion, removal, and wearing forces while being responsive to deliberate reshaping efforts.

The ear hooks in accordance with the present invention may be manufactured using overmolding techniques where the malleable core element 129 is positioned within a mold and the elastomeric covering material is molded around it. Alternative manufacturing methods include insert molding, where the malleable core element 129 is inserted into a pre-formed elastomeric housing, or co-extrusion processes for continuous production methods.

In the embodiments disclosed, the hardness of the elastomeric covering may vary to optimize comfort and grip characteristics. In one embodiment of the present invention, the elastomeric covering has a durometer of between 20 and 80 on the Shore A hardness scale. The selection of covering hardness is coordinated with the malleable core element 129 properties to ensure appropriate force transmission for user customization while maintaining comfort during extended wear.

While copper wire represents a preferred embodiment, the malleable core element 129 may comprise various materials including aluminum alloys, brass, zinc alloys, thermoplastic elastomers, fiber-reinforced polymer composites, or shape memory materials. Each material selection provides different characteristics in terms of force required for reshaping, shape retention properties, and environmental resistance.

In certain embodiments, the malleable core element 129 extends along only a portion of the length of the ear frame 120, rather than the entire length. This partial-length configuration provides targeted malleability in specific regions while maintaining different mechanical properties in other regions of the ear frame. The partial-length malleable core element may extend between 40% and 90% of the total length of the ear frame, and more preferably between 50% and 80% of the total length.

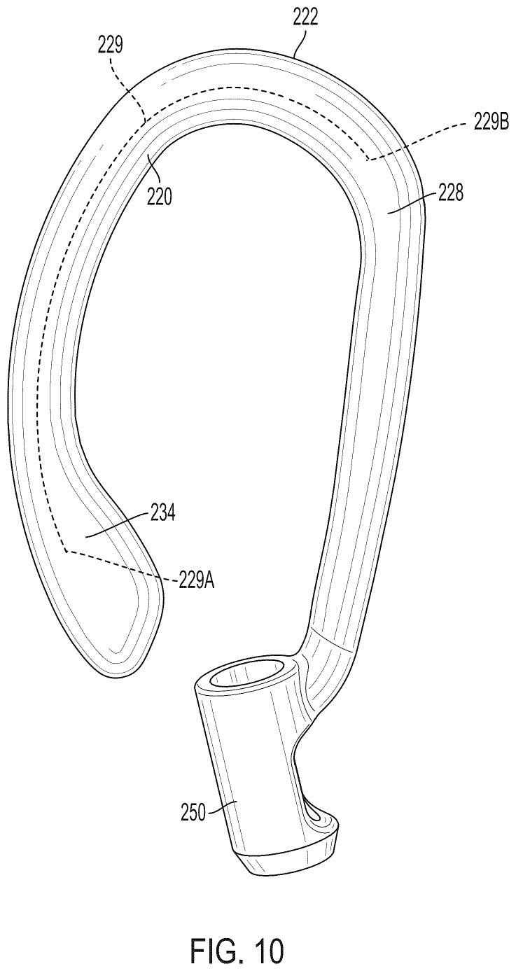

As illustrated in FIG. 10, the malleable core element 229 extends from proximate the area 234 near the second end of the ear frame 220 and extends approximately two-thirds of the length toward the first end, terminating before reaching the earbud receiver 250. This configuration provides malleability in the upper curve portion 222 while allowing the lower portion near the receiver to maintain consistent positioning relative to the earbud.

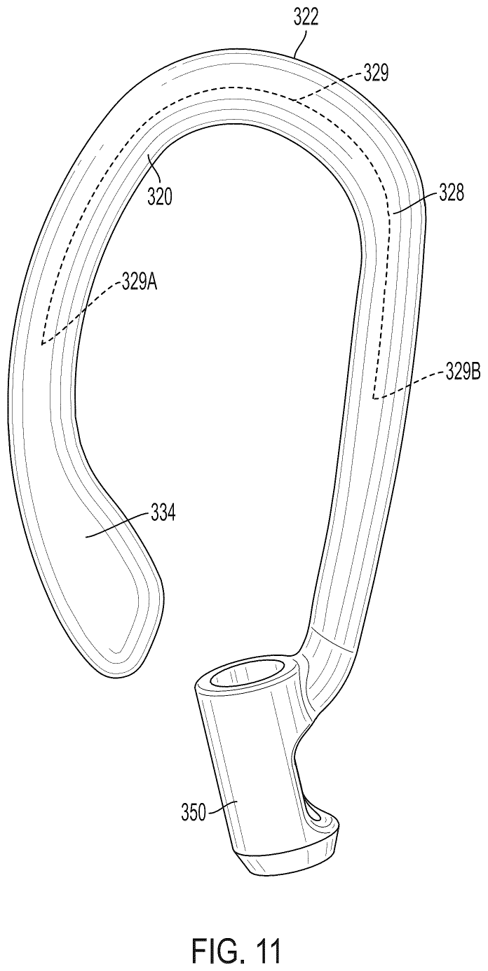

As illustrated in FIG. 11, the malleable core element 329 is positioned centrally within the ear frame 320, extending approximately two-thirds of the total ear frame length and centered at the top portion 322. The malleable core element 329 includes portions 329A and 329B that provide balanced malleability on both sides of the apex of the ear frame curve. This central positioning enables customization of the primary ear-engaging curve while maintaining structural stability at both terminal ends.

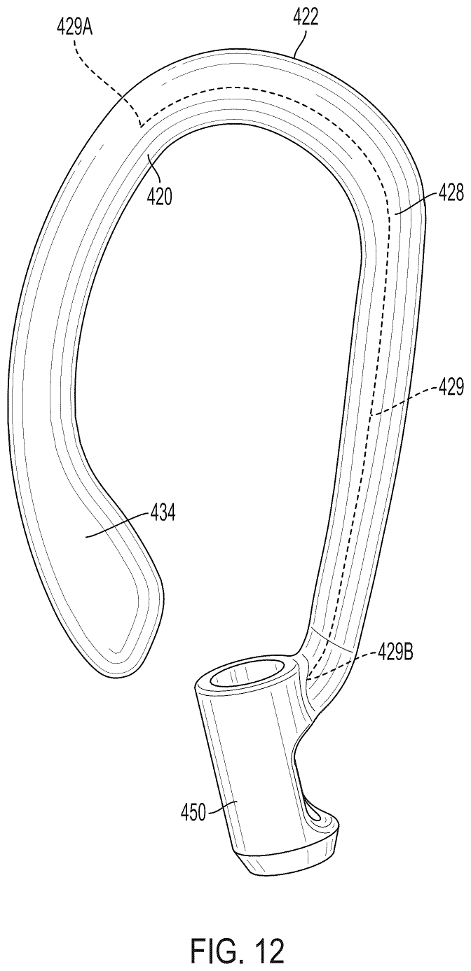

As illustrated in FIG. 12, the malleable core element 429 extends from proximate the first end near the earbud receiver 450 and extends approximately two-thirds of the length of the ear frame 420 toward the second end. This configuration enables adjustment of the ear frame shape near the ear canal and over the top of the ear while maintaining a stable terminal portion at area 434.

The variable-length malleable core elements provide several advantages including: reduced material cost while maintaining functionality; differentiated flexibility zones within a single ear hook; prevention of over-bending in critical connection areas; and the ability to create hybrid rigid-flexible designs. The specific length and positioning of the malleable core element within the ear frame can be optimized based on biomechanical analysis of typical user adjustment patterns and stress distribution during use.

A person of skill in the invention and familiar with this disclosure will understand that different lengths of core element are possible. The present invention further encompasses embodiments wherein the malleable core element comprises multiple segments of different lengths positioned at strategic locations within the ear frame. For example, two or more shorter malleable core segments may be positioned with rigid sections between them, creating defined bending zones while maintaining structural integrity in intermediate regions. Additionally, the invention includes configurations where the malleable core element varies in diameter or cross-sectional area along its length, providing graduated flexibility from one region to another.

The present invention encompasses various design configurations including different ear frame geometries, core element cross-sections (circular, oval, rectangular), and core element positioning within the elastomeric covering. Multiple core elements may be used in parallel for enhanced shape retention or variable stiffness along the ear frame length.

It should be understood that the present invention is not limited to the specific configurations, shapes, or embodiments disclosed herein. The malleable core ear hook system can be implemented in various alternative configurations including different ear frame geometries (such as J-shapes, S-curves, or custom contoured profiles), alternative cross-sectional shapes for both the ear frame and malleable core element (including oval, rectangular, triangular, or multi-strand configurations), varying core element positioning within the elastomeric covering (centered, offset, or multiple parallel cores), and different earbud receiver orientations and attachment methods. The invention encompasses ear hooks designed for various earbud types and manufacturers, different user demographics (including pediatric and oversized configurations), and alternative material combinations that achieve the same functional result of user-customizable shape retention. Furthermore, the principles of the present invention may be applied to other audio device retention systems, sports equipment retention devices, or any application requiring user-adjustable shape memory functionality while maintaining the essential characteristics of permanent deformation capability and structural integrity described herein.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

What is claimed is:

1. A system for positioning an earbud relative to the ear of a person, the system comprising:
an ear frame extending between a first end and a second end, the ear frame having a top portion disposed between the first end and the second end, the ear frame defining a first side that is adjacent to a head of the person and a second side that is oppositely disposed relative to the first side;
an earbud receiver configured to receive a stem of an earbud, the earbud receiver connected to the ear frame proximate to the first end of the frame;
a malleable core element embedded within the ear frame, the malleable core element having sufficient plasticity to undergo permanent deformation when subjected to manual bending forces while maintaining structural integrity, whereby the ear frame retains a user-configured shape after manual adjustment; and
an elastomeric covering encasing the malleable core element.

2. The system of claim 1, wherein the malleable core element has a yield strength between 40 and 200 MPa.

3. The system of claim 1, wherein the malleable core element has a diameter between 0.016 inches and 0.040 inches.

4. The system of claim 1, wherein the malleable core element comprises a metal selected from the group consisting of copper, aluminum, brass, zinc, and alloys thereof.

5. The system of claim 1, wherein the yield strength of the malleable core element exceeds the tensile strength of the elastomeric covering by a factor of at least 5:1.

6. The system of claim 1, wherein the malleable core element extends along a length of the ear frame between an area proximate the first end and an area proximnate the second end.

7. The system of claim 1, wherein the elastomeric covering comprises silicone having a Shore A hardness between 20 and 80.

8. The system of claim 1, wherein the malleable core element has an elongation at break of at least 10%.

9. An ear hook for an earbud having a stem extending therefrom, the ear hook comprising:
an ear frame extending between a first end and a second end and defining a C-shape between the first end and the second end;
an earbud receiver connected to the first end of the ear frame, the earbud receiver configured to receive the stem of the earbud;
a wire core embedded within the ear frame, the wire core having a yield strength between 70 and 150 MPa and a diameter between 0.020 inches and 0.035 inches, the wire core being sufficiently malleable to permit manual reshaping while providing shape retention after deformation; and
a silicone covering molded around the wire core.

10. The ear hook of claim 9, wherein the wire core comprises annealed copper.

11. The ear hook of claim 9, wherein the wire core has a gauge between 18 AWG and 26 AWG.

12. The ear hook of claim 9, wherein the wire core comprises oxygen-free copper.

13. The ear hook of claim 9, wherein the silicone covering has a tensile strength between 2 and 8 MPa.

14. The ear hook of claim 9, wherein the wire core has a yield strength between 70 and 100 MPa.

15. The ear hook of claim 9, wherein the wire core comprises a solid conductor.

16. The ear hook of claim 9, wherein the wire core extends continuously from proximate the first end to proximate the second end of the ear frame.

17. A customizable ear retention device comprising:
a curved frame portion configured to extend around at least a portion of a user's ear;
an earbud coupling portion connected to the curved frame portion;
a shape-memory element incorporated within the curved frame portion, the shape-memory element being manually deformable to assume and retain a user-selected configuration; and
a flexible outer layer surrounding the shape-memory element.

18. The device of claim 17, wherein the shape-memory element comprises a material selected from the group consisting of metals, metal alloys, thermoplastic elastomers, fiber-reinforced polymer composites, and shape memory polymers.

19. The device of claim 17, wherein the shape-memory element has mechanical properties enabling permanent deformation under manual force while resisting deformation under normal use conditions.

20. The device of claim 17, wherein the flexible outer layer comprises a material having elastic properties substantially different from the shape-memory element.

21. The device of claim 17, wherein the shape-memory element extends along a majority of the length of the curved frame portion.
